(19) United States
(12) Patent Application Publication
(10) Pub. No.: US 2014/0100789 A1
(43) Pub. Date: Apr. 10, 2014

(54) NUCLEIC READS ALIGNING DEVICE AND ALIGNING METHOD THEREOF

(71) Applicant: Electronics and Telecommunications Research Institute, Daejeon (KR)

(72) Inventors: Jae Hun CHOI, Daejeon (KR); Minho KIM, Daejeon (KR); Myung-eun LIM, Daejeon (KR); Ho-Youl JUNG, Daejeon (KR); Soo Jun PARK, Seoul (KR)

(73) Assignee: Electronics and Telecommunications Research Institute, Daejeon (KR)

(21) Appl. No.: 14/038,456

(22) Filed: Sep. 26, 2013

(30) Foreign Application Priority Data
Oct. 4, 2012 (KR) 10-2012-0110160

(51) Int. Cl. G06F 19/22

(52) U.S. Cl. CPC G06F 19/22
USPC 702/19

(57) ABSTRACT

Provided is a nucleic reads aligning method. More particularly, the present invention relates to a nucleic reads aligning method using a many-core process. A nucleic reads aligning device aligning a set of nucleic reads of a sequence to be analyzed with a reference sequence according to the present invention includes a main memory storing the reference sequence and the set of nucleic reads, a main processor splitting the reference sequence to produce first and second reference sequence fragments, and a many-core module aligning the set of nucleic reads with each of the first and second reference sequence fragments in parallel. The nucleic reads aligning device and method according to the present invention split a reference sequence and quickly align nucleic reads in a many-core environment.

### CROSS-REFERENCE TO RELATED APPLICATIONS

This U.S. non-provisional patent application claims priority under 35 U.S.C. §119 of Korean Patent Application No. 10-2012-0110160, filed on Oct. 4, 2012, the entire contents of which are hereby incorporated by reference.

### BACKGROUND OF THE INVENTION

The present invention disclosed herein relates to a nucleic reads aligning method. More particularly, the present invention relates to a nucleic reads aligning method using a many-core process.

As a human genome project HGP is completed, there is a need for a technology in which sequencing may be quickly performed at less cost. Next-generation sequencing (NGS) that is being recently developed may perform parallel-processing on massive data, and thus is more efficient than an existing first-generation Sanger technique in terms of a speed and a cost.

According to the NGS, a sequence to be analyzed is cut to have a small size and thus nucleic reads are produced. The produced nucleic reads form a library. The nucleic reads are amplified and then aligned with a reference genome sequence, such as an analyzed human genome. It is possible to discover a variant letter by comparing the aligned nucleic reads with the reference sequence.

The nucleic reads used in the NGS have a smaller size than the reference sequence and the number of the nucleic reads is larger than that of the reference sequence. For example, when one nucleic read has a length of a 100 base unit, the number of nucleic reads to be used for sequencing may be equal to or larger than one billion. Thus, there is a need for a technology to efficiently align the nucleic reads in parallel.

### SUMMARY OF THE INVENTION

The present invention provides a nucleic reads aligning device and an aligning method thereof that splits a reference sequence and quickly aligns nucleic reads in a many-core environment.

Embodiments of the present invention provide nucleic reads aligning devices for aligning a set of nucleic reads of a sequence to be analyzed with a reference sequence, the nucleic reads aligning device including a main memory storing the reference sequence and the set of nucleic reads; a main processor splitting the reference sequence to produce first and second reference sequence fragments; and a many-core module aligning the set of nucleic reads with each of the first and second reference sequence fragments in parallel.

In some embodiments, the many-core module may include a plurality of cores that are connected in parallel, wherein the plurality of cores includes a first group of cores and a second group of cores, wherein the first group of cores align the set of nucleic reads with the first reference sequence fragment and the second group of cores align the set of nucleic reads with the second reference sequence fragment.

In other embodiments, the main processor may group the set of nucleic reads to produce first and second nucleic read clusters, wherein the many-core module aligns the first and second nucleic read clusters with each of the first and second reference sequence fragments and alignment operations of the first and second nucleic read clusters are performed in parallel.

In still other embodiments, the first group of cores may include a first small group of cores and a second small group of cores, wherein the first small group of cores aligns the first nucleic read cluster with the first reference sequence fragment and the second small group of cores aligns the first nucleic read cluster with the second reference sequence fragment.

In even other embodiments, the main processor may integrate alignment results of each of the first and second reference sequence fragments.

In yet other embodiments, the nucleic reads aligning device may further include a reference sequence database storing the reference sequence; and a nucleic read database storing the set of nucleic reads, wherein the main processor loads the reference sequence from the reference sequence database onto the main memory, and loads the set of nucleic reads from the nucleic read database onto the main memory.

In other embodiments of the present invention, nucleic reads aligning methods for aligning a set of nucleic reads of a sequence to be analyzed with a reference sequence, the method may include splitting the reference sequence into a plurality of reference sequence fragments; grouping the set of nucleic reads into a plurality of nucleic read clusters; and aligning the plurality of nucleic read clusters with each of the plurality of reference sequence fragments in parallel.

In some embodiments, the method may further include loading the reference sequence from a database onto a main memory, wherein the splitting of the reference sequence into the plurality of reference sequence fragments comprises splitting the loaded reference sequence into the plurality of reference sequence fragments.

In other embodiments, the method may further include integrating alignment results of the plurality of reference sequence fragments.

In still other embodiments, the alignment result may include a location of each nucleic read in the set of nucleic reads and accuracy corresponding to the location, wherein the integrating of the alignment results of the plurality of reference sequence fragments may include: selecting a candidate location of each nucleic read according to the accuracy; comparing the accuracy corresponding to the candidate location with a threshold; and determining whether to map each nucleic read, according to the comparison result.

In even other embodiment, the determining of whether to map each nucleic read, according to the comparison result may include mapping each nucleic read to the candidate location if the accuracy corresponding to the candidate is equal to or greater than the threshold.

In yet other embodiments, the splitting of the reference sequence into the plurality of reference sequence fragments may include calculating the optimal number of splits; splitting the reference sequence into sections of a number corresponding to the optimal number of splits; and adding an overlapped region to the split reference sequence to produce the plurality of reference sequence fragments.

In further embodiments, the optimal number of splits may be determined based on a length of the reference sequence and an operation environment of a many-core module.

In still further embodiments, a length of the overlapped region may be determined based on a length of the nucleic read.

In even further embodiments, the length of the overlapped region may be one base shorter than that of the nucleic read.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a block diagram of a nucleic reads aligning device according to an embodiment of the present invention;

FIG. 2 is a diagram of an embodiment of setting kernels of FIG. 1;

FIG. 3 is a flowchart of a nucleic reads aligning method according to an embodiment of the present invention;

FIG. 4 is a flowchart of a method of splitting a reference sequence according to an embodiment of the present invention;

FIG. 5 is a diagram for explaining a method of splitting a reference sequence of the present invention; FIG. 5 includes the following sequence ID numbers:

| | |
|---|---|
| SEQ ID NO: 1: | attcggatac accgactaac aactgggcat atc |
| SEQ ID NO: 2: | attcggataca |
| SEQ ID NO: 3: | caccgactaa |
| SEQ ID NO: 4: | aacaactggg |

FIG. 6 is a flowchart for explaining an operation of a many-core module of the present invention in more detail; and

FIG. 7 is a flowchart of an integrating an alignment result of each reference sequence fragment.

### DETAILED DESCRIPTION OF PREFERRED EMBODIMENTS

Hereinafter, preferred embodiments of the present invention will be described with reference to the accompanying drawings to fully explain the present invention in such a manner that it may easily be carried out by a person with ordinary skill in the art to which the present invention pertains. In addition, the terms to be used below are only to describe the present invention and not to limit the scope of the present invention. It should be construed that foregoing general illustrations and following detailed descriptions are exemplified and an additional explanation of claimed inventions is provided.

As an example, a nucleic reads aligning device according to an embodiment of the present invention operates in a compute unified device architecture (CUDA) environment. However, it is an example and the operation environment of the nucleic reads aligning device of the present invention is not limited thereto.

In the present embodiment, a kernel refers to a function that enables a compiler to be executed in a device code region, the compiler having been executed in a host code region. In addition, in the present embodiment, the host code is a code that is executed in a host, namely, in a main module side, and the device code is a code that is executed in a device, namely, in a many-core module side. One kernel produces one grid. The grid is a work processing unit of a kernel executing device side. The grid may include a plurality of blocks. Each block may include a plurality of threads. Each thread will be driven by a CUDA core.

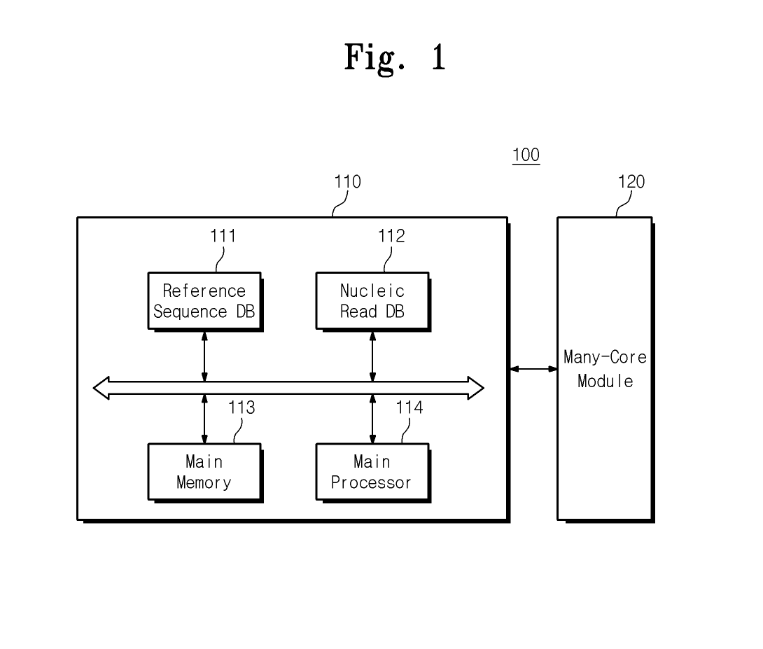

FIG. 1 is a block of a nucleic reads aligning device according to an embodiment of the present invention. Referring to FIG. 1, the nucleic reads aligning device 100 includes a main module 110 and a many-core module 120.

The nucleic reads aligning device 100 splits a reference sequence. The nucleic reads aligning device 100 may align nucleic reads in parallel with the split reference sequences by using the many-core module. Since the split reference sequences are shorter than the entire reference sequence in length, an alignment speed of the nucleic reads aligning device 100 is faster than when the reference sequence is not split.

The main module 110 controls a nucleic reads aligning operation. The main module 110 includes a reference sequence database (DB) 111, a nucleic reds database (DB) 112, a main memory 113, and a main processor 114.

The reference sequence database 111 stores a reference sequence. The reference sequence is a sequence that is used for comparison with nucleic reads. When an attempt is made to analyze all of sequences of a person, the reference sequence will be all of human sequences of about three billion bases.

The nucleic read database 112 stores a set of nucleic reads. The nucleic reads refer to sequence fragments that are obtained by cutting the sequence to be analyzed. The nucleic reads are amplified and then compared and aligned with a reference sequence. In general, the total length of the set of the amplified nucleic reads may be about 30 times longer than a length of the reference genome sequence.

That is, when attempting to analyze all of sequences of a person, the total length of the set of nucleic reads will be about 90 billion bases. However, in the present embodiment, the amplified amount of the nucleic reads is not limited thereto.

The main memory 113 stores data that is required for an operation of the main module 110. In response to control of the main processor 114, the reference genome sequence stored in the reference sequence database 111 is loaded onto the main memory. In addition, in response to control of the main processor 114, the set of nucleic reads stored in the nucleic read database 112 is loaded onto the main memory.

The main processor 114 may be a multi-core type central processing unit (CPU). The main processor 114 splits the reference sequence loaded onto the main memory 113 into reference sequence fragments. The number of fragments into which the reference sequence is split may be adjusted depending on throughput of the many-core module 120.

In addition, the main processor 114 groups the set of nucleic reads loaded onto the main memory 113 to produce nucleic read clusters. The number of the nucleic read clusters is determined based on the number of blocks that belong to one kernel.

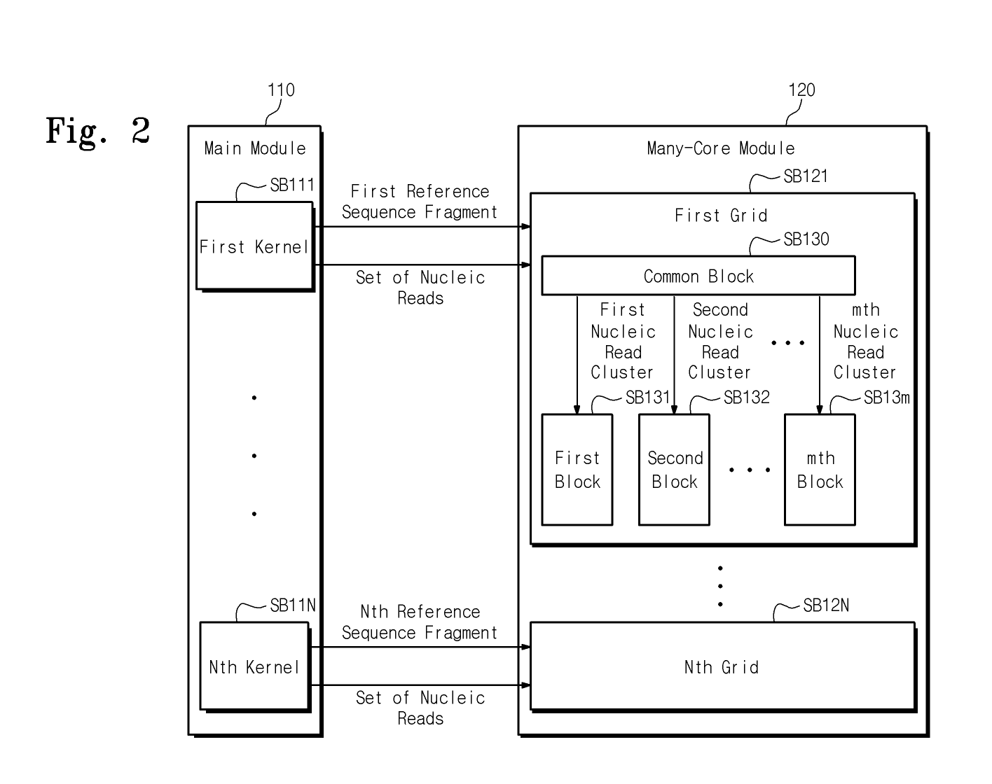

The main processor 114 sets kernels on the basis of the number of reference sequence segments to be produced and the number of nucleic read clusters. The main processor 114 allocates each of the reference sequence fragments to each kernel. In addition, the main processor allows the nucleic read clusters to be allocated to each block of each kernel. An operation of the main processor 114 will be described in more detail with reference to FIG. 2.

The many-core module 120 aligns nucleic reads with the reference sequence fragments in response to a set kernel. The many-core module 120 may be a many-core type graphics processing unit (GPU).

The many-core module 120 includes more arithmetic logic units (ALUs) than the main processor 114. The many-core module 120 is difficult to make a complex calculation which is made by the main processor 114. However, the many-core module 120 may quickly make a lot of simple calculations in parallel.

The main processor 114 integrates the alignment result of the reference sequence fragments by the many-core module 120 to calculate an alignment result of the entire reference sequences.

In summary, the nucleic reads aligning device 100 splits a reference sequence. The nucleic reads aligning device 100 may align a set of nucleic reads in parallel with reference sequence fragments that are obtained by splitting the reference sequence. The nucleic reads aligning device 100 integrates alignment information of the reference sequence fragments. Since the reference sequence fragments are shorter than the entire reference sequence in length, an alignment speed of the nucleic reads aligning device 100 is faster than when the reference sequence is not split.

In order to enhance efficiency of a nucleic reads aligning process, the nucleic reads aligning device 100 according to the present embodiment processes complex operations such as splitting a reference genome sequence and integrating alignment information thereof by using the main processor 114. In addition, the nucleic reads aligning device 100 quickly processes simple sequence comparison operations by using the many-core module 120. Thus, a nucleic reads aligning speed of the nucleic reads aligning device 100 may increase. An operation of the nucleic reads aligning device 100 will be described below in more detail with reference to FIG. 2.

FIG. 2 is a diagram of an embodiment of setting kernels of FIG. 1.

Firstly, the main processor 114 (see FIG. 1) splits a reference sequence loaded onto the main memory 113 (see FIG. 1) into N reference sequence fragments. The number of the reference sequence fragments will be determined based on a length of a reference sequence and an operation environment of the many-core module 120 (see FIG. 1).

The main processor 114 produces kernels SB111 to SB11N with the same number as that of the reference sequence fragments. The main processor 114 allocates the reference sequence fragments to the kernels. For example, a first reference sequence fragment is allocated to a first kernel.

In addition, the main processor 114 groups a set of nucleic reads loaded onto the main memory 113 into m nucleic read clusters. The number of the nucleic read clusters will be determined based on an operation environment of the many-core module 120 (see FIG. 1), such as the number of cores. The main processor 114 provides the grouped set of nucleic reads to each kernel.

One kernel produces one grid corresponding thereto. N kernels SB111 to SB11N will produce N grids SB121 to SB12N. Since an operation and a configuration of one grid are similar to those of another grid, FIG. 2 illustrates only a first grid in detail.

As described above, the grid is a work processing unit of a kernel executing device side. One grid may be driven by a group of CUDA cores that includes a plurality of cores. In the present embodiment, one grid aligns a set of nucleic reads with reference to one reference sequence fragment.

The first grid SB 121 includes a plurality of blocks SB 131 to SB13m. Each block may perform parallel-operation. One block may be driven by a small group of CUDA cores that includes a plurality of cores. As described above, each block may include a plurality of threads. One thread may be driven by one CUDA core.

In addition, the first grid may include a common block SB130. The plurality of blocks SB131 to SB 13m may share an access to the common block SB130.

The first grid SB130 stores a first reference sequence fragment and a grouped set of nucleic reads in the common block SB130. The plurality of blocks SB131 to SB13m are allocated each nucleic read cluster of the grouped set of nucleic reads. For example, the first block SB131 is allocated a first nucleic read cluster.

One block aligns one nucleic read cluster with reference to the first reference sequence fragment. Alignment operations of the plurality of blocks SB131 to 513m are made in parallel with one another. Based on the nucleic read alignment operation, it is determined where each nucleic read belonging to a nucleic read cluster coincides with a reference sequence fragment and how much the coincidence is accurate.

Each block may be formed as a single instruction multiple data (SIMD) type in which a plurality of threads, namely, a sub operation core is controlled by one control unit. A nucleic reads aligning algorithm that is performed in each block may be one that is implemented in an SIMD type block. For example, nucleic reads may be aligned by using a Smith-Waterman algorithm, a Blast algorithm or a Fata algorithm. However, these are examples and the present invention is not limited thereto.

The main processor 114 integrates alignment results of a set of nucleic reads with each reference sequence fragment calculated in each kernel, an alignment operation of each kernel is completed. The main processor 114 calculates the alignment results of the set of nucleic reads with the entire reference sequences based on an integrated result.

In order to enhance the efficiency of a nucleic reads aligning process, the nucleic reads aligning device 100 splits a reference sequence, and quickly processes nucleic reads aligning operations of reference sequence fragments by using a plurality of kernels. In addition, the nucleic reads aligning device 100 performs nucleic reads aligning operations on reference sequence fragments in parallel on a nucleic read cluster basis, by using a plurality of blocks. Thus, a nucleic reads aligning speed of the nucleic reads aligning device 100 may increase.

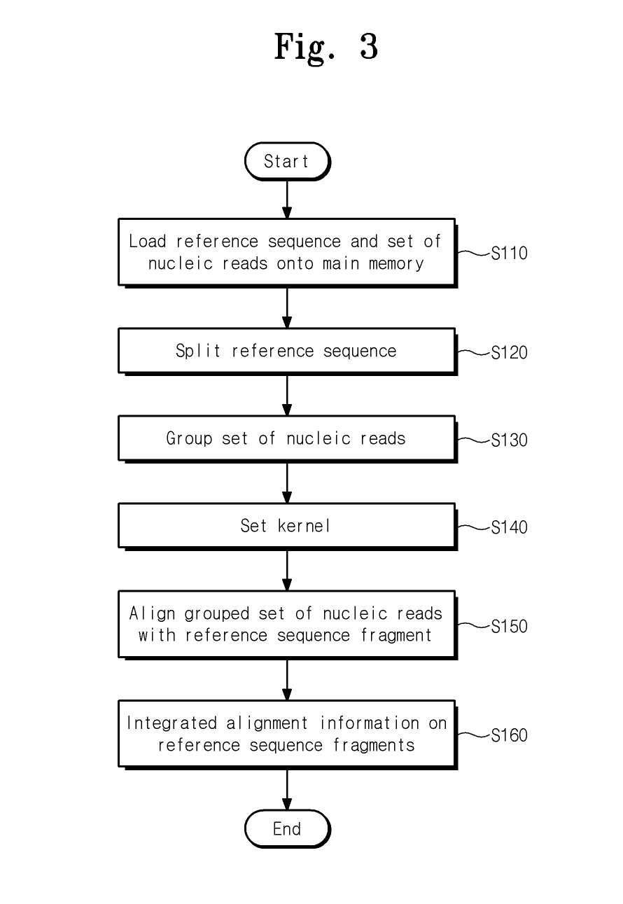

FIG. 3 is a flowchart of a nucleic reads aligning method according to an embodiment of the present invention.

In step S110, the main processor 114 (see FIG. 1) loads a reference sequence and a set of nucleic reads from a database onto the main memory 113 (see FIG. 1). The database that stores the reference sequence and the set of nucleic reads may be stored in a non-volatile memory.

In step S120, the main memory 114 splits the reference sequence into a plurality of reference sequence fragments. The number of fragments into which the reference sequence is split may vary depending on an operation environment of a many-core module and a length of the reference sequence.

In step S130, the main processor 114 groups the set of nucleic reads into a plurality of nucleic read clusters. The number of the nucleic read clusters may vary depending on an operation environment of a many-core module and the number of nucleic reads.

In step S140, a kernel is set based on the number of the reference sequence fragments. The number of kernels to be produced may be the same as the number of the reference sequence fragments. Each kernel is allocated one reference sequence fragment.

In step S150, the grouped set of nucleic reads is aligned with the reference sequence fragments. The set of nucleic reads may aligned on a nucleic read cluster basis in parallel.

In step S160, alignment results of the set of nucleic reads with reference sequence fragments are integrated. An alignment result of the set of nucleic reads with the entire reference sequence is calculated based on the integrated result.

In the nucleic reads aligning method according to the present embodiment, a reference sequence is split, and nucleic reads aligning operations on the reference sequence fragments are quickly processed by using a plurality of kernels. In addition, the nucleic reads aligning method is quick in alignment speed because nucleic reads aligning operations on the reference sequence fragments are performed in parallel on a nucleic read cluster basis by using a plurality of blocks. Thus, the entire nucleic read aligning speed of the nucleic reads aligning device 100 may increase.

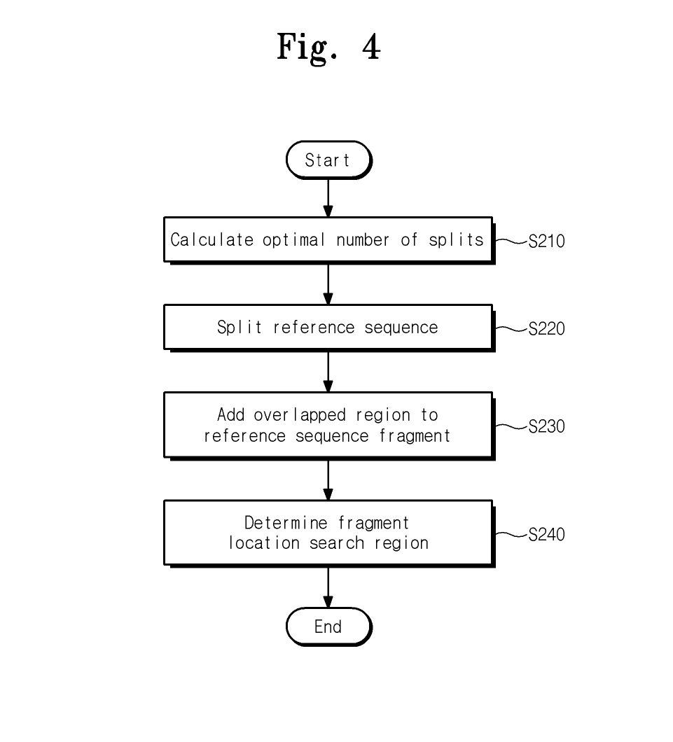

FIG. 4 is a flowchart of a method of splitting a reference sequence according to an embodiment of the present invention. According to the method of splitting the reference sequence of the present invention, since an overlapped region is added to the reference sequence fragment, it is possible to perform a nucleic read aligning operation without a missing part.

In step S210, the optimal number of splits of the reference sequence is calculated. The optimal number of splits of the reference sequence may be determined based on a length of the reference sequence and an operation environment of a many-core module. Alternatively, the optimal number of splits may be a value that is preset in the nucleic reads aligning device.

In step S220, the reference sequence is split to have the calculated optimal number of splits. The sizes of the reference sequence fragments that are obtained by splitting the reference sequence are not necessarily the same.

In step S230, an overlapped region is added to each reference sequence fragment. In the present embodiment, the overlapped region is added to the end of the reference sequence fragment. However, it may vary depending on a nucleic reads aligning algorithm.

In the nucleic reads aligning algorithm according to the present embodiment, when one nucleic read is aligned, a comparison operation starts with a first base of the nucleic read. Thus, in order for the nucleic read to be normally compared with a last base of the reference sequence fragment, an overlapped region that has a length (a length of the nucleic read—1) should be added to behind the last base of the reference sequence fragment. In addition, when performing the comparison operation between the nucleic read and the reference sequence, overlapped regions that correspond to allowable further bases will be able to be added if adding and deleting bases are considered.

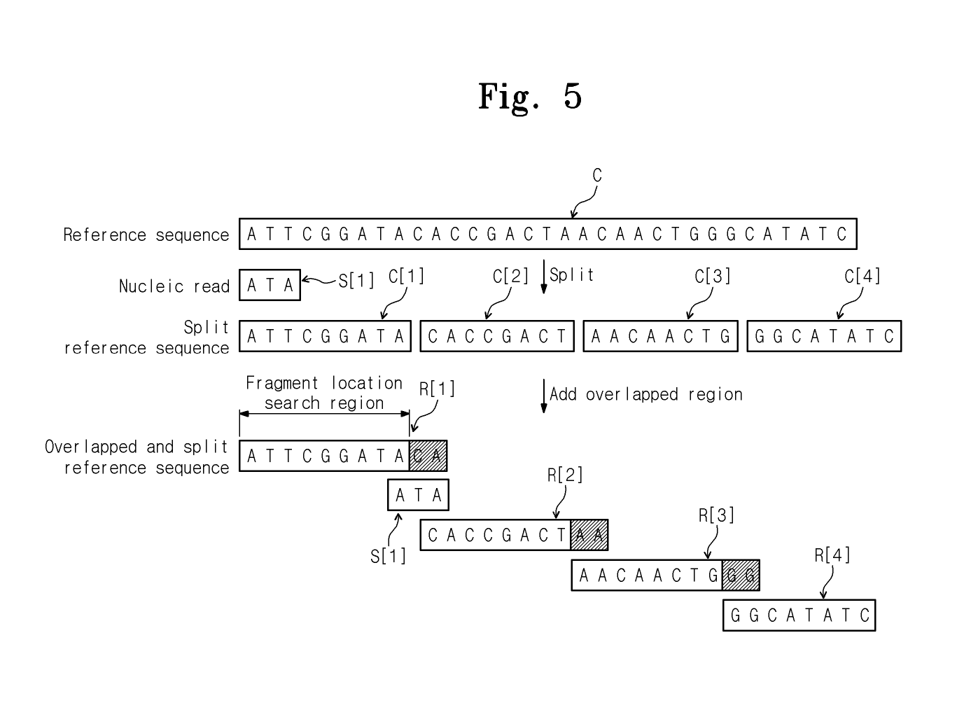

In step S240, a fragment location search region is determined with respect to each reference sequence fragment. The fragment location searching region is where a comparison operation to a first base is performed when one nucleic read is aligned. In the present embodiment, the fragment location searching region will be a first base to a (a length of the nucleic read)th base from last in a reference sequence fragment to which an overlapped region is added. The fragment location searching region will be described in more detail with reference to FIG. 5.

According to a method of splitting the reference sequence of the present invention, since an overlapped region is added to the reference sequence fragment, it is possible to perform a nucleic reads aligning operation without a missing part.

FIG. 5 is a diagram for explaining a method of splitting a reference sequence of the present invention. Referring to FIG. 5, a long reference sequence C is first split into a plurality of primary reference sequence fragments C[1] to C[4]. In this application, the primary reference sequence fragment is used as the same meaning as the split reference sequence.

Overlapped regions (represented by gray color) is added to the primary reference sequence fragments C[1] to C[4] to form reference sequence fragments R[1] to R[4]. In this application, the reference sequence fragment is used as the same meaning as a overlapped split reference sequence. The overlapped region is the leading bases of a fragment following the current primary reference sequence fragment. A length of the overlapped region is determined based on a length of a nucleic read S[1] to be compared to the reference sequence (C). The fragment location searching region is where the leading base of the nucleic read S[1] may be compared in the reference sequence fragments R[1] to R[4]. That is, it indicates a region of each of the reference sequence fragments R[1] to R[4] that the primary reference sequence fragments C[1] to C[4] occupy.

According to a method of splitting a reference sequence of the present invention, an overlapped region is added to a reference sequence fragment and a fragment location searching region is set, and it is thus possible to perform a nucleic reads aligning operation without a mission part.

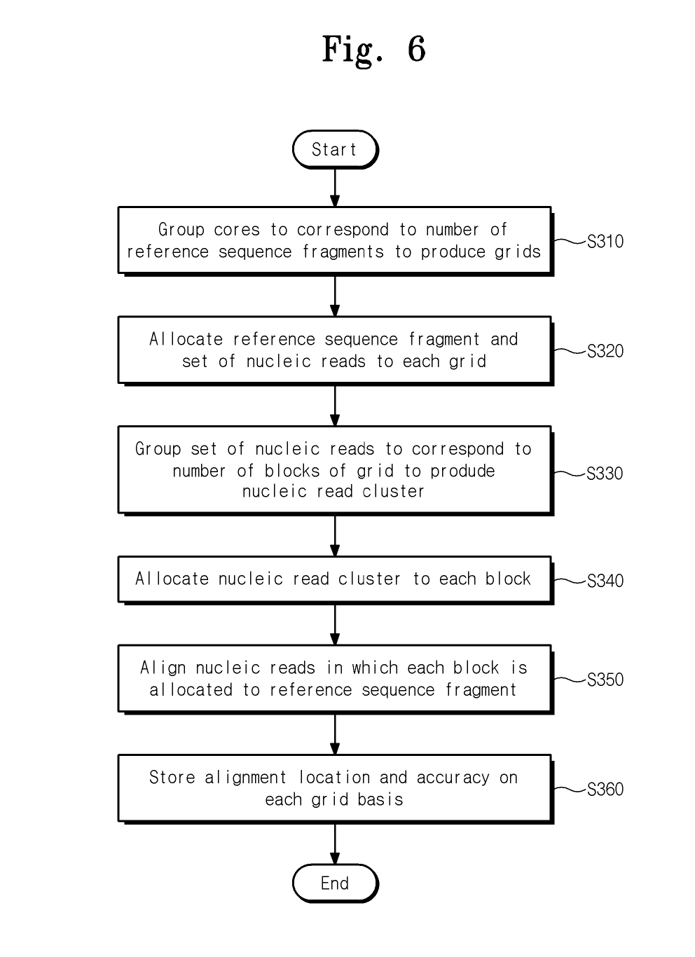

FIG. 6 is a flowchart for explaining an operation of a many-core module of the present invention in more detail.

In step S310, in response to a kernel, cores of the many-core module form groups of the same number as the number of reference sequence fragments. One core group drives one grid. Grids may be driven in parallel.

In step S320, a reference sequence fragment is allocated to each grid. In addition, a set of nucleic reads is provided to each grid.

In step S330, the set of nucleic reads is grouped with the number of blocks in the grid. The number of blocks in the grid may vary depending on the number of cores that configure one block. In addition, a grouping operation of the set of nucleic reads may be made on a host, namely, on a main module side.

In step S340, a nucleic read cluster is allocated to each block.

In step S350, each block aligns nucleic reads in the nucleic read cluster that is allocated to the block, with reference to the reference fragment allocated to the grid. Nucleic reads aligning operations of blocks may be performed in parallel. In addition, the nucleic reads aligning algorithm is not limited thereto.

In step S360, alignment results from each block are summed, and an alignment result of a set of nucleic reads with a reference sequence fragment is stored on a grid basis. The alignment result includes an alignment location of each nucleic read with a reference sequence fragment and an alignment accuracy thereof. The stored alignment result may be transmitted to a main memory of a main module. Alternatively, the stored alignment result may be transmitted to a global memory of the many-core module.

Since the many-core module according to the present embodiment simply performs a comparison operation in the alignment process, an operation speed may be enhanced in proportion to the number of cores. In addition, since the many-core module allocates each reference sequence fragment to each grid and performs an operation, and each grid may operate in parallel, a processing speed may be further enhanced.

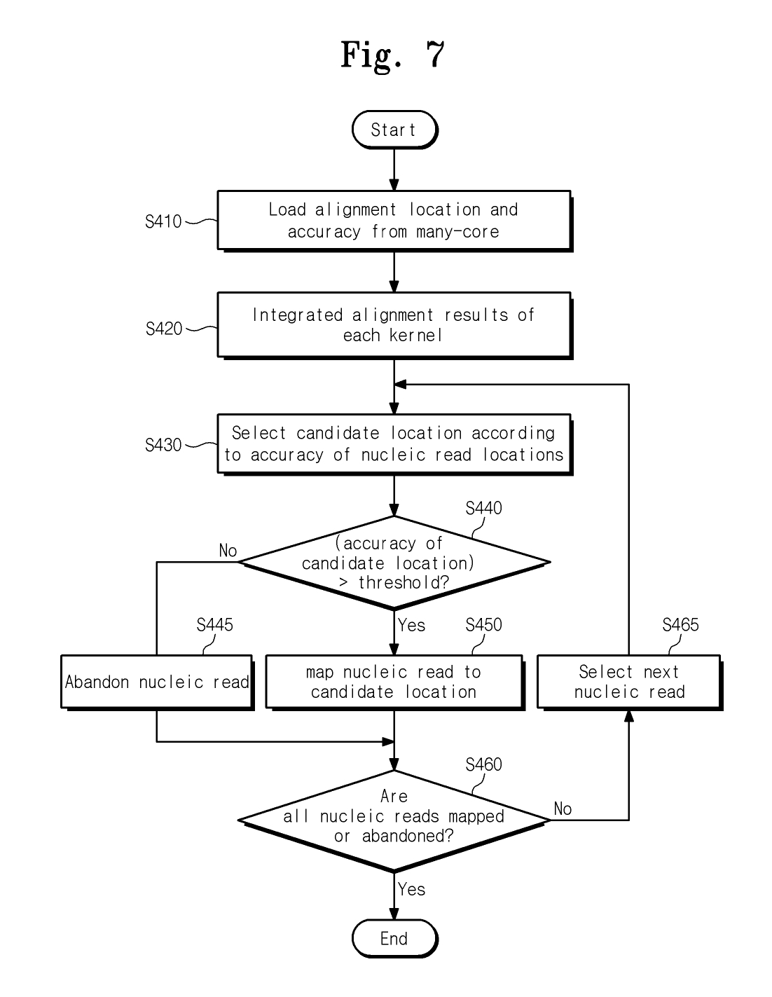

FIG. 7 is a flowchart of a method of integrating an alignment result of each reference sequence fragment.

In step S410, an alignment result of a set of nucleic reads with each reference sequence fragment onto a main memory from a many-core module. The alignment result includes a location of nucleic reads and a level of accuracy.

In step S420, the alignment result of the set of nucleic reads with the entire reference sequence is integrated. One nucleic read will have location information and accuracy information regarding each reference sequence fragment. That is, regarding the entire reference sequence, one nucleic read will be aligned with a plurality of locations with different accuracies, in an overlapped manner.

In step S430, an alignment location with the highest accuracy is selected as a candidate location among alignment locations of each nucleic read.

In step S440, the accuracy of the selected alignment location is compared with a predesignated threshold. In step S445, if the accuracy of the selected alignment location is smaller than the predesignated threshold, the nucleic read is not mapped but abandoned.

In step S450, if the accuracy of the candidate location is equal to or greater than the predesignated threshold, the nucleic read is mapped to the candidate location.

In steps S460 and S465, the nucleic read mapping operations S430 through S450 are repeated until all nucleic reads are mapped or abandoned.

According to the method of integrating alignment results of reference sequence fragments, all nucleic reads in a set of nucleic reads may be mapped to a location with the highest accuracy.

While particular embodiments have been described in the detailed description of the present invention, various variations may be made without departing from the present invention. For example, a detailed configuration of the many-core module of the main module will be able to be changed or altered depending on a usage environment or use. The specific terms herein are used to explain the present invention and not to limit meanings thereof or restrict the scope of the present invention that is described in the claims. Therefore, the scope of the present invention should not be limited to the embodiments described above but should be defined by the following claims and their equivalents.

What is claimed is:

1. A nucleic reads aligning device for aligning a set of nucleic reads of a sequence to be analyzed with a reference sequence, the nucleic reads aligning device comprising:
a main memory storing the reference sequence and the set of nucleic reads;
a main processor splitting the reference sequence to produce first and second reference sequence fragments; and
a many-core module aligning the set of nucleic reads with each of the first and second reference sequence fragments in parallel.

2. The nucleic reads aligning device of claim 1, wherein the many-core module comprises a plurality of cores that are connected in parallel, wherein the plurality of cores includes a first group of cores and a second group of cores, wherein the first group of cores align the set of nucleic reads with the first reference sequence fragment and the second group of cores align the set of nucleic reads with the second reference sequence fragment.

3. The nucleic reads aligning device of claim 2, wherein the main processor groups the set of nucleic reads to produce first and second nucleic read clusters, wherein the many-core module aligns the first and second nucleic read clusters with each of the first and second reference sequence fragments and alignment operations of the first and second nucleic read clusters are performed in parallel.

4. The nucleic reads aligning device of claim 3, wherein the first group of cores comprises a first small group of cores and a second small group of cores, wherein the first small group of cores aligns the first nucleic read cluster with the first reference sequence fragment and the second small group of cores aligns the first nucleic read cluster with the second reference sequence fragment.

5. The nucleic reads aligning device of claim 1, wherein the main processor integrates alignment results of each of the first and second reference sequence fragments.

6. The nucleic reads aligning device of claim 1, further comprising:
a reference sequence database storing the reference sequence; and
a nucleic read database storing the set of nucleic reads, wherein the main processor loads the reference sequence from the reference sequence database onto the main memory, and loads the set of nucleic reads from the nucleic read database onto the main memory.

7. A nucleic reads aligning method for aligning a set of nucleic reads of a sequence to be analyzed with a reference sequence, the method comprising:
splitting the reference sequence into a plurality of reference sequence fragments;
grouping the set of nucleic reads into a plurality of nucleic read clusters; and
aligning the plurality of nucleic read clusters with each of the plurality of reference sequence fragments in parallel.

8. The method of claim 7, further comprising loading the reference sequence from a database onto a main memory, wherein the splitting of the reference sequence into the plurality of reference sequence fragments comprises splitting the loaded reference sequence into the plurality of reference sequence fragments.

9. The method of claim 7, further comprising integrating alignment results of the plurality of reference sequence fragments.

10. The method of claim 9, wherein the alignment result comprises a location of each nucleic read in the set of nucleic reads and accuracy corresponding to the location,
wherein the integrating of the alignment results of the plurality of reference sequence fragments comprises:
selecting a candidate location of each nucleic read according to the accuracy;
comparing the accuracy corresponding to the candidate location with a threshold; and
determining whether to map each nucleic read, according to the comparison result.

11. The method of claim 10, wherein the determining of whether to map each nucleic read, according to the comparison result comprises mapping each nucleic read to the candidate location if the accuracy corresponding to the candidate is equal to or greater than the threshold.

12. The method of claim 7, wherein the splitting of the reference sequence into the plurality of reference sequence fragments comprises:
calculating an optimal number of splits;
splitting the reference sequence into sections of a number corresponding to the optimal number of splits; and
adding an overlapped region to the split reference sequence to produce the plurality of reference sequence fragments.

13. The method of claim 12, wherein the optimal number of splits is determined based on a length of the reference sequence and an operation environment of a many-core module.

14. The method of claim 12, wherein a length of the overlapped region is determined based on a length of the nucleic read.

15. The method of claim 14, wherein the length of the overlapped region is one base shorter than that of the nucleic read.


SEQUENCE LISTING (4 sequences)

SEQ ID NO: 1 - DNA, 33 bp, Unknown
  Exemplary sequence for explaining the invention
attcggatacaccgactaacaactgggcatatc

SEQ ID NO: 2 - DNA, 11 bp, Unknown
  exemplary sequence for explaining the invention
attcggataca

SEQ ID NO: 3 - DNA, 10 bp, Unknown
  exemplary sequence for explaining the invention
caccgactaa

SEQ ID NO: 4 - DNA, 10 bp, Unknown
  exemplary sequence for explaining the invention
aacaactggg